(19) United States
(12) Patent Application Publication
(10) Pub. No.: US 2014/0036276 A1
(43) Pub. Date: Feb. 6, 2014

(54) SENSING SPECIMEN GRIPPER

(71) Applicant: Beckman Coulter, Inc., Brea, CA (US)

(72) Inventors: Mark Gross, Laguna Niguel, CA (US); Edward A. Murashie, Santa Ana, CA (US); Santiago Allen, Yorba Linda, CA (US); Allan Trochman, Corona, CA (US); Stefan Rückl, Munchen (DE); Stephan L. Otts, Fishers, IN (US)

(73) Assignee: Beckman Coulter, Inc., Brea, CA (US)

(21) Appl. No.: 13/960,479

(22) Filed: Aug. 6, 2013

Related U.S. Application Data
(60) Provisional application No. 61/790,446, filed on Mar. 15, 2013.
(60) Provisional application No. 61/714,656, filed on Oct. 16, 2012.
(60) Provisional application No. 61/680,066, filed on Aug. 6, 2012.

(51) Int. Cl. G01B 11/02; G01N 21/17; G01B 7/12

(52) U.S. Cl. CPC G01B 11/02; G01B 7/12; G01N 21/17
USPC 356/614; 324/714; 356/213; 73/862.68; 356/445; 356/634; 356/402

(57) ABSTRACT

Systems and methods for system for gripping a specimen container are disclosed. The system comprises a plurality of gripper fingers, a processor, and a system for gathering data related to a specimen container. Data related to a specimen container, such as detection of the presence of a specimen container within the gripper, measurement of specimen container dimensions and weight, detection of specimen container contents, specimen tube identification, etc. are gathered. Embodiments provide an improved automated process by simultaneously performing multiple measurements and analytical processes on the specimen container, thereby providing for faster processing of the sample that resides in the specimen container.

### CROSS-REFERENCES TO RELATED APPLICATIONS

This application is a non-provisional application of and claims the benefit of priority of U.S. Provisional Application No. 61/790,446 filed on Mar. 15, 2013, U.S. Provisional Application No. 61/714,656 filed on Oct. 16, 2012, and U.S. Provisional Application No. 61/680,066 filed on Aug. 6, 2012, each of which is herein incorporated by reference in its entirety for all purposes.

### BACKGROUND

Conventional medical laboratory systems contain many segments for processing patient samples, some of which are automated and some of which require manual operation. Laboratory systems today have become more efficient due to those segments which have become automated. However, there are still several components of medical laboratory systems that can be automated in order to reduce the time it takes for an analysis of a sample, reduce the need for manual operation of the system, and reduce the space required by machinery.

When automating sample tube manipulation (loading, uploading devices, such as racks, instruments, conveyors) normally done by lab technicians additional handling is required to manage unknown variations such as, sticky labels, various diameters, heights, cap styles, cap colors, etc. to avoid mishandling tubes, for example, dropping, misplacing, breaking or otherwise affecting quality and time to result. Broken tubes, folded labels and other obstructions could lead to crashes etc. This may lead to hazard to lab technicians, cross contamination with other patients and may require redraws.

Other problems to be addressed relate to the speed of processing. It takes time for automated systems to automatically characterize specimen container if there are many types of specimen containers in a laboratory. It also takes time for automated systems to automatically characterize specimens inside of the specimen containers if there are many types of specimens in a laboratory. In automated specimen processing systems, the throughput and speed of processing specimens is of primary importance.

There is a need for an improved automation system for efficient management of the samples.

### BRIEF SUMMARY

Embodiments of the technology relate to systems and methods for gripping specimen containers.

One embodiment is directed to a system for gripping a specimen container. The system comprises a plurality of gripper fingers and a processor. The system also includes a sensing potentiometer communicatively coupled to the processor. The sensing potentiometer is configured to produce an output based on a distance between two gripper fingers in the plurality of gripper fingers when a specimen container is gripped in the plurality of gripper fingers. The processor is configured to determine a dimension (e.g., a diameter) of the specimen container based on the output of the sensing potentiometer.

Another embodiment is directed to a method for determining a diameter of a specimen container. The method comprises gripping the specimen container using a plurality of gripper fingers, and generating, by a sensing potentiometer, an output based on a distance between two gripper fingers in the plurality of gripper fingers. The method further comprises determining, by a processor coupled to the sensing potentiometer, a dimension (e.g., a diameter) of the specimen container based on the output.

In another embodiment, the system for gripping a sample tube comprises a plurality of gripper fingers, a processor and a load cell communicatively coupled to the processor. The processor is configured to determine a weight of the specimen container based on an output of the load cell.

Another embodiment is directed to a method for determining a weight of a specimen container. The method comprises gripping the specimen container using a plurality of gripper fingers and generating an output by a load cell. The method further comprises determining, by a processor coupled to the load cell, a weight of the specimen container based on the output.

In a further embodiment, the system for gripping a sample tube comprises a plurality of gripper fingers, a processor, and an optical sensor system. The optical sensor system includes a light source and a light receiver. The light source may be communicatively coupled to the processor and the light receiver may be communicatively coupled to the processor. The light source may be coupled to a first gripper finger and the light receiver may be coupled to a second gripper finger. The optical sensor system can be used to determine whether a specimen container is present between the gripper fingers, a length of a specimen container, and one or more liquid levels within a specimen container.

Another embodiment is directed to a method for obtaining information associated with a specimen container. The method comprises transmitting, by a light source, an optical signal, the light source coupled to a first gripper finger in a plurality of gripper fingers gripping the specimen container and receiving, by a light receiver, the optical signal, the light receiver being coupled to a second gripper finger in the plurality of gripper fingers gripping the specimen container. The method further comprises determining, by a processor coupled to the light source and the light receiver, information associated with the specimen container gripped by the plurality of gripper fingers.

Another embodiment is directed to a system for obtaining information from a specimen container. The system comprises a plurality of gripper fingers, a processor, a photo transistor communicatively coupled to the processor, and a light emitting diode. The light emitting diode is configured to generate light that is reflected from a surface of a cap of the specimen container when the specimen container is gripped by the plurality of gripper fingers. The photo transistor is configured to generate a signal corresponding to a quantity of reflected light from the surface of the cap of the sample container.

Another embodiment is directed to a method for obtaining information from a specimen container. The method comprises transmitting light generated by a light emitting diode directed towards a cap of the specimen container and receiving light reflected from a surface of the cap of the specimen container by a photo transistor communicatively coupled to a processor, wherein the photo transistor is configured to generate a signal corresponding to a quantity of reflected light from the surface of the cap of the specimen container.

Another embodiment of the invention is directed to a specimen gripper that includes a plurality of gripper fingers, a load cell for determining a weight of a specimen container held by the gripper fingers, a potentiometer for determining a dimension of the specimen container, and a light source and a light receiver respectively associated with the gripper fingers.

These and other embodiments of the technology are described in further detail below.

### BRIEF DESCRIPTION OF THE DRAWINGS

A further understanding of the nature and advantages of the different embodiments may be realized by reference to the following drawings.

FIG. 1 depicts an example of a Cartesian or gantry robot with three independently moveable directions x-, y-, and z-.

FIG. 2 depicts a block diagram of a system in one embodiment.

FIG. 3 depicts a gripper unit having sensing capabilities in one embodiment.

FIG. 4. depicts a linear potentiometer and a fiber optic system in one embodiment.

FIG. 5. shows an illustrative specimen carrier with cutouts to allow optical access to a specimen container in one embodiment.

FIG. 6. shows an illustrative fiber optic system having multiple light sources in one embodiment.

FIG. 7 shows an exemplary laser emitting diode and photodiode optical sensing system in one embodiment.

FIGS. 8A-8B illustrate a ball screw assembly for closing gripper fingers of a specimen gripper about a specimen container.

FIGS. 9A-9D show a worm drive assembly for closing gripper fingers of a specimen gripper about a specimen container.

FIGS. 10A-10D show a slotted disc assembly for closing gripper fingers of a specimen gripper.

FIGS. 11A-11B show a planetary gear assembly for closing gripper fingers of the specimen gripper.

FIGS. 11C-11D show sections of the specimen gripper viewed from below planetary gear system.

FIG. 12 depicts a block diagram of an exemplary computer apparatus.

### DETAILED DESCRIPTION

Embodiments of the present technology relate to a specimen gripper (which may be referred to as a smart gripper) for grasping specimen containers. These embodiments, as will be described in more detail below, are advantageous because they provide systems for gathering various data related to a specimen container, such as detection of the presence of a specimen container within the gripper, measurement of specimen container dimensions and weight, detection of specimen container contents, specimen tube identification, etc. Some or all of this information can be gathered during a specimen container transport or manipulation process. Further, because the specimen gripper has the ability to characterize a specimen container as well as the specimen inside of it, there is no need to provide for separate characterization equipment, thereby reducing space requirements and expense. Embodiments of the invention provide an improved automated process by simultaneously performing multiple measurements and analytical processes on the specimen container, thereby providing for faster processing of the sample that resides in the specimen container.

The specimen container may be a sample tube. A sample tube may contain material for medical analysis, such as blood, serum, gel, plasma, etc.

The specimen gripper may be used in a medical laboratory system for processing patient samples. The specimen gripper may be equipped with one or more means for detecting information about specimen containers that it grips. In some embodiments, a specimen gripper may be coupled to a robotic arm. Robotic arms may be used for transportation of specimen containers in various areas of a laboratory system, such as input, distribution, centrifuge, decapper, aliquotter, output, sorting, recapping, and secondary tube lift areas.

The specimen gripper may have a plurality of gripper fingers including a first gripper finger, a second gripper finger, etc. Each gripper finger may take a form of an elongated structure that is capable of gripping an object such as a sample tube in collaboration with one or more other gripper fingers. In some embodiments, an exemplary gripper finger may have a rectangular, axial and/or longitudinal, cross-section with predetermined thickness (e.g., one quarter of an inch or more) and length (e.g., three inches or more). Suitable gripper fingers may be rigid or may have one or more pivoting regions.

A specimen gripper according to an embodiment of the invention may utilize plurality of gripper fingers to grip an object. The plurality of gripper fingers may comprise two or more (e.g., three, four or any suitable number) gripper fingers. In a preferred embodiment, the plurality of gripper fingers comprises three gripper fingers. In some embodiments, a jaw may be coupled to one end (gripping end) of the gripper finger to aid in gripping the object. The other end of the gripper finger may be coupled to an assembly or mechanism along with other gripper fingers that may be operable to control the gripper fingers for gripping the object.

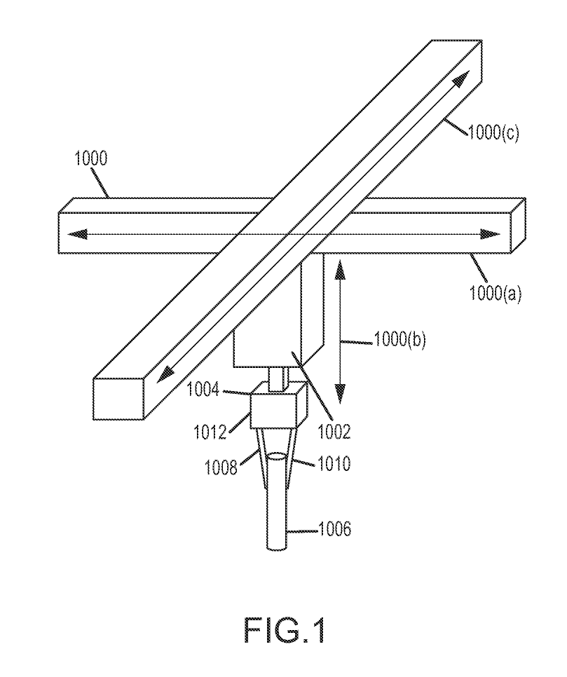

The robotic arm architecture can differ in complexity dependent upon the given task. FIG. 1 depicts an example of a Cartesian or gantry robot 1000 with three independently moveable directions x-, y-, and z-. The gantry robot 1000 shown in FIG. 1 shows a simple robotic arm 1002 that can move up and down. More complex robotic arms may include, for example, a Selective Compliant Assembly Robot Arm (SCARA) or an articulated robotic arm with multiple joint arms.

In some embodiments of the invention, a specimen gripper 1004, may be coupled to the robot arm 1002. The robot arm 1002 may be part of the gantry robot 1000 that is configured to move independently in three, orthogonal directions denoted as 1000(a), 1000(b) and 1000(c). As the specimen gripper 1004 is transported by the robot arm 1002, the specimen gripper 1004 may transport a specimen container 1006 held by the specimen gripper 1004.

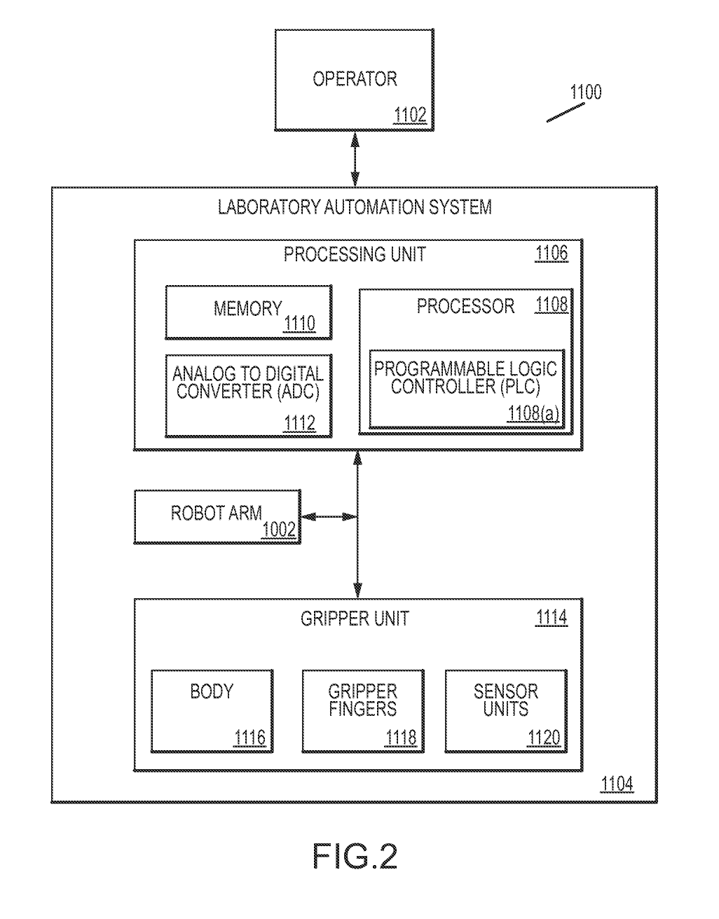

The specimen gripper 1004 may have two or more moveable gripper fingers 1008, 1010 coupled to a body 1012 to grip the specimen container 1006. For example, the gripper fingers 1008, 1010 may move inwardly toward the specimen container 1006 until the specimen container 1006 is held in a fixed position between the gripper fingers 1008 and 1010. The gripper fingers 1008, 1010 may also be configured to spread outwardly to release the specimen container 1006. The robot arm 1002 may be part of a laboratory automation system as further described with reference to FIG. 2.

FIG. 2 illustrates a block diagram of a system 1100 that may be utilized in a medical laboratory. The system 1100 may include an operator 1102 that may use a laboratory automation system 1104 to process samples (e.g., serum, plasma, gel, packed red blood cells, etc.). In the exemplary embodiment, the laboratory automation system 1104 includes the robot arm 1002, a processing unit 1106 and a gripper unit 1114. However, a number of other units (not shown) may be utilized by the laboratory automation system 1104. For example, the laboratory automation system 1104 may include an input module, a distribution area, a centrifuge, a decapper, a serum indices measurement device, an aliquotter and an output/sorter in some embodiments of the invention. The robot arm 1002 may be part of the gantry robot 1000. The gripper unit 1114 may be configured to communicate with the processing unit 1106.

The processing unit 1106 may include a processor 1108, a memory 1110, and an analog to digital converter (ADC) 1112. The processor 1108 may further include a programmable logic controller (PLC) 1108(a). In one embodiment, the ADC 1112 can be part of the PLC 1108(a). In some embodiments, the processor may include other suitable processing elements (not shown), such as a microprocessor, a digital signal processor, a graphics processor, a co-processor, etc.

The processor 1108 may be configured to execute instructions or code in order to implement methods, processes or operations in various embodiments. For example, in some embodiments of the invention, a sensing potentiometer may be communicatively coupled to the processor. The potentiometer can be configured to produce an output based on a distance between the two gripper fingers in the plurality of gripper fingers when a specimen container is gripped in the plurality of gripper fingers. The processor can be configured to determine a dimension (e.g., a diameter) of the specimen container based on the output. In other embodiments, a load cell in the gripper unit may be communicatively coupled to the processor. The processor can be configured to determine a weight of the specimen container based on an output of the load cell. In some embodiments, a light source coupled to a first gripper finger in a plurality of gripper fingers gripping a specimen container and a light source coupled to a second gripper finger in a plurality of gripper fingers gripping the specimen container may be coupled to the processor. The processor can be configured to determine information (e.g., presence, length, liquid level and characteristics, etc.) associated with the specimen container gripped by the plurality of gripper fingers.

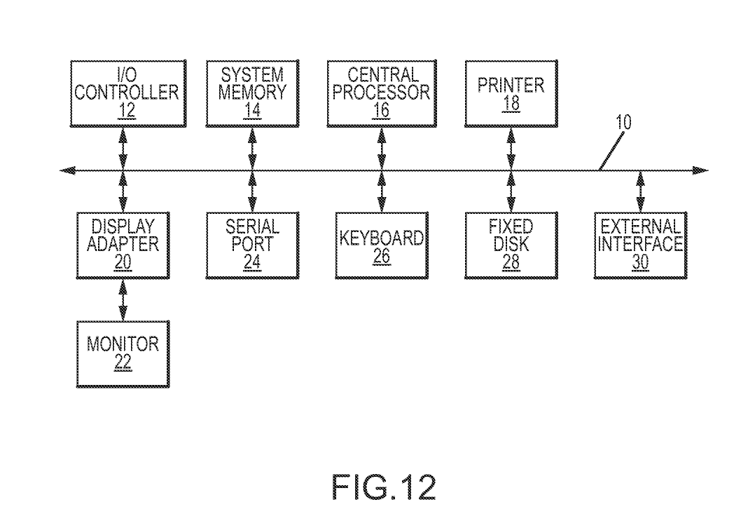

The memory 1110 may be coupled to the processor 1108 internally or externally (e.g., cloud based data storage) and may comprise any combination of volatile and/or non-volatile memory such as, for example, buffer memory, RAM, DRAM, ROM, flash, or any other suitable memory device. In some embodiments, the memory 1110 may be in the form of a computer readable medium (CRM), and may comprise code, executable by the processor 1108 for implementing methods described herein. In some embodiments, the processor 1108 may be part of a computer system as described with reference to FIG. 12.

The memory 1110 may also store other information. Such information may include identification data for various specimens and specimen containers, gripper unit weight information, data correlating potentiometer outputs to specimen dimensions, data correlating load sensor outputs to specific weights, data correlating characteristics of different light signals to different container types and/or specimen types. By identifying the liquid characteristics of one or more liquid samples within the specimen container, the samples may be processed differently. For example, a specimen container with a first characteristics of one or more liquid samples within the specimen container could be directed to a storage unit by a gripper unit (coupled to a robotic arm), whereas, a specimen container with a second characteristics of one or more liquid samples within the specimen container could be directed to a centrifuge.

The PLC 1108(a) may be configured to receive, store, analyze and/or process data from the ADC 1112, the gripper unit 1114 or any other unit interfacing with the gripper unit 1114. In some embodiments, the PLC 1108(a) may include one or more of a microcontroller, a digital to analog converter, an analog to digital converter, an amplifier, timer, memory, power circuit or any other support logic.

The ADC 1112 may be configured to receive an analog input (voltage or current) and convert it to a digital value corresponding to the magnitude of the analog input. The ADC 1112 may be implemented as a delta sigma converter, a high-speed pipeline converter, a successive approximation register or any such suitable type of converter.

The laboratory automation system 1104 may utilize the robot arm 1002 to grip a specimen container (e.g., sample tube) using the gripper unit 1114. The gripper unit 1114 may include a body 1116, gripper fingers 1118 that are coupled to the body 1116, and sensor units 1120. It will be understood that the gripper unit 1114 may also include or interface with other units to enable the gripper unit perform the intended function.

The sensor units 1120 may include one or more sensor units to detect/provide information associated with the specimen container that may be used by the processing unit 1106 for efficient processing of samples. In some embodiments, the information provided by the sensors may be used to determine dimensions of the specimen container (e.g., diameter, length, cap color, etc.), level and characteristics of one or more samples contained in the specimen container, etc. For example, the sensor units 1120 may include a sensing potentiometer for determining a dimension (e.g., a diameter) of the specimen container, and/or an optical/fiber optic sensor system for determining a presence of the specimen container and/or liquid characteristic/level, a length of the specimen container, etc. In one embodiment, the gripper unit 1114 may be configured to work in conjunction with a load cell to determine a weight of the specimen container.

In one embodiment, the gripper fingers 1118 and the sensor units 1120 are coupled to the body 1116. The body 1116 may be in the form of a support structure or a housing. It may have any suitable shape including a square or rectangular vertical or horizontal cross section. The gripper fingers 1118 can be capable of moving with respect to the body 1116, while the sensor units 1120 may be stationary and fixed to and/or enclosed by the body 1116. In one embodiment, the body 1116 may include one or more mounting structures so that the gripper fingers 1118 and the sensor units 1120 are coupled to the one or more mounting structures. The body 1116 may be made of any suitable material including metal or plastic.

In some embodiments, the body 1116 may include or couple to one or more assembly units that allow for opening and closing of the gripper fingers 1118. For example, the body 1116 may include a worm drive assembly, a slotted disc assembly or a planetary gear assembly for closing or opening the plurality of gripper fingers about the specimen container. These assembly units are described in further detail below.

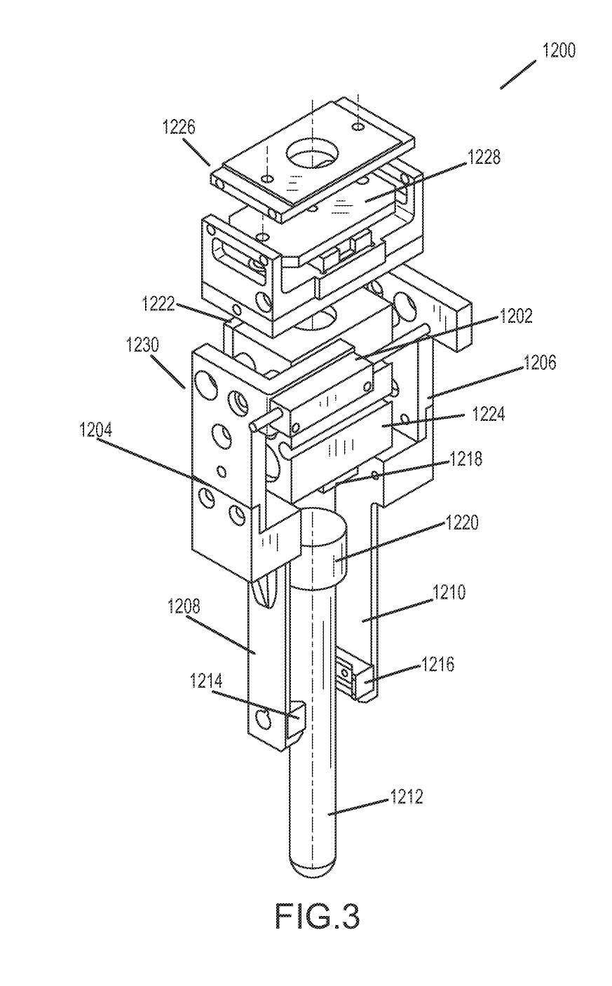

FIG. 3 depicts a gripper unit 1200 having sensing capabilities in one embodiment.

The gripper unit 1200 may include a sensing potentiometer 1202, first and second mounting structures 1204 and 1206, gripper fingers 1208 and 1210, an optical sensor unit 1218, and a pneumatic actuator 1224. A load sensor unit 1226 may be used in conjunction with the gripper unit 1200. The gripper unit 1200 may be coupled to the robot arm 1002 (in FIG. 1) and can grip a specimen container 1212 using the gripper fingers 1208 and 1210.

In some embodiments, the specimen container 1212 is gripped by replaceable jaws 1214 and 1216 coupled to the gripper fingers 1208 and 1210, respectively. The replaceable jaws 1214, 1216 can have any suitable shape or size, and are desirable since they can be replaced to accommodate sample tubes of different shapes. For example, the jaws 1214, 1216 may have facing convex surfaces to accommodate the convex surface of the specimen container 1212. Thus, in some embodiments, surfaces of the jaws 1214, 1216 may be cooperatively configured with respect to a surface of the specimen container 1212. In embodiments of the invention, the jaws 1214, 1216 can also be easily replaced when they are worn or defective. In some embodiments, the replaceable jaws can be made of any suitable material including a soft or hard plastic material. In some embodiments, the jaws 1214, 1216 may be integrally formed with the gripper fingers 1208, 1210, thus forming unitary structures.

In one embodiment, the specimen container 1212 may have a cylindrical shape with a circular cross-section. In one embodiment, a diameter of the specimen container 1212 can be interpreted as a width of the specimen container 1212 (i.e., as measured by an outer diameter of the specimen container 1212) or a length of a straight line passing through the center of the specimen container 1212 and connecting with two points on the surface of the specimen container 1212.

In one embodiment, the specimen container 1212 may have a cap 1220. The cap 1220 may have a cylindrical shape with a circular cross-section and a diameter slightly larger than the diameter of the specimen container 1212 and a length relatively shorter than the length of the specimen container 1212. It will be understood that other shapes and sizes of the specimen container 1212 and the cap 1220 are possible that can be gripped by the gripper unit 1200. The cap 1220 may have a specific color such as red, green, or blue.

The mounting structures 1204 and 1206 may be part of a body 1230 of the gripper unit 1200. In one embodiment, the mounting structures 1204 and 1206 have a similar shape and each mounting structure 1204, 1206 is coupled to a corresponding gripper finger 1208, 1210. For example, the mounting structure 1204 is coupled to the gripper finger 1208 and the mounting structure 1206 is coupled to the gripper finger 1210. In one embodiment, each of the mounting structures 1204 and 1206 comprise a rectangular structure with a certain thickness (e.g., quarter inch) and means for coupling to various sensor units and the gripper fingers.

In one embodiment, the sensing potentiometer 1202 is disposed between the first and second mounting structures 1204 and 1206. In one embodiment, the sensing potentiometer 1202 includes housing with a rectangular cross-section and support for coupling to the mounting structures 1204 and 1206. The sensing potentiometer 1202 may include a resistive element with varying resistance. In one embodiment, the sensing potentiometer 1202 is a linear potentiometer which provides a resistance value that changes proportionally to the distance between the gripper fingers 1208 and 1210. The sensing potentiometer 1202 may be configured to produce an output based on a distance between the gripper fingers 1208 and 1210. In one embodiment, the output is a voltage value corresponding to the resistance value of the linear potentiometer 1202 that may be provided to the PLC 1108(a). When a specimen container such as the specimen container 1212 is gripped by the gripper fingers 1208 and 1210, a diameter of the specimen container 1212 can be determined based on a signal corresponding to the resistance value of the linear potentiometer 1202. The gripper fingers 1208, 1210 can move inwardly towards each other when they are used to secure the specimen container 1212.

In one embodiment, the pneumatic actuator 1224 is disposed between the first and second mounting structures 1204 and 1206. In one embodiment, the pneumatic actuator 1224 includes housing with a rectangular cross-section and support means for coupling to the mounting structures 1204 and 1206. In one embodiment, the pneumatic actuator 1224 is configured to control the movement of the gripper fingers 1208, 1210. In some embodiments, the positions of gripper fingers 1208 and 1210 can be determined based on the control signal to the pneumatic actuator 1224. In one embodiment, the diameter of the specimen container 1212 can be determined based on a signal sent to (or received from) the pneumatic actuator 1224 indicating the position of one or both gripper fingers 1208, 1210. In some embodiments, the pneumatic actuator 1224 may consist of a piston, a cylinder and valves or ports.

In one embodiment, the optical sensor unit 1218 may be arranged between the first and second mounting structures 1204 and 1206 using support means. The optical sensor unit 1218 may include one or more optical sensors. For example, the gripper unit 1200 may have an optical sensor (e.g. OPB732WZ by Optek) including a light emitting diode and a phototransistor. The light emitting diode can transmit light toward the cap 1220 of the specimen container 1212 and the phototransistor can sense light reflected from the cap 1220. The output current of the phototransistor can be proportional to the amount of light reflected, providing an indication of the distance between the phototransistor of the optical sensor 1218 and the top of the cap 1220.

The gripper unit 1200 can be configured to pick up the specimen container 1212 at a uniform distance from the bottom of the specimen container 1212, allowing the specimen container length from the bottom of the tube 1212 to the top of the cap 1220 to be determined based on the distance between the optical sensor 1218 and the cap 1220. For example, a voltage corresponding to the current output of the phototransistor can be received by the PLC 1108(a) and can be used to determine the distance between the optical sensor 1218 and the cap 1220 and corresponding length of the specimen container 1212. In some cases, the length of the specimen container 1212 may be used to identify the type of sample contained in the specimen container 1212 if samples of the same type are in samples tubes with similar lengths. In one embodiment, a camera controller 1222 can be used to provide instructions to and receive data from the optical sensor 1218. The light reflected from the cap 1220 may be used for other purposes as well. For example, in some embodiments, the color of the cap 1220 can be determined thereby identifying the particular specimen container associated with the cap.

Some embodiments of the invention are directed to methods. Such methods include transmitting light generated by a light emitting diode directed towards a cap of the specimen container (e.g., cap 1220 of the specimen container 1212), and receiving light reflected from a surface of the cap of the specimen container by a photo transistor communicatively coupled to a processor (e.g., processor 1108). The photo transistor is configured to generate a signal corresponding to a quantity of reflected light from the surface of the cap of the specimen container.

In some embodiments, the optical sensor 1218 of the gripper unit 1200 is a camera, such as a CMOS color camera (e.g., OV7680 Color CMOS VGA by OmniVision). An optical sensor that is a camera can provide information about the specimen container, such as a cap color. The camera can also provide information about a rack of specimen tubes (e.g., sample tubes), such as filled and unfilled rack positions.

A load sensor unit 1226 may be used in conjunction with gripper unit 1200. The load sensor unit 1226 may comprise a load cell 1228 that may operate as a transducer to convert a force into an electrical signal. In one embodiment, the load sensor unit 1226 may be arranged on top of the gripper unit 1200. The load cell 1228 can generate a signal that can be used to determine a weight, such as a combined weight of the specimen container 1212 and the gripper unit 1200. For example, an output of the load cell 1228 may be provided to the PLC 1108(a) via the ADC 1112. In one embodiment, the output is on the order of a few millivolts and may require amplification by an amplifier. Some types of load cells may include hydraulic load cells, pneumatic load cells, or strain gauge load cells. The PLC 1108(a) can further process the output of the load cell 1228 to determine a weight of the specimen container 1212. The load cell 1228 may be, e.g. an FS20 load cell by Measurement Specialties. A known weight of the gripper unit 1200 can be subtracted from the combined weight to determine the weight of the specimen container 1212. This weight can be used, for example, to aid in balancing the centrifuge buckets in a centrifuge.

Some embodiments of the invention are directed to methods. Such methods may include gripping the specimen container using a plurality of gripper fingers, and generating, by a load cell, an output. In one embodiment, the gripped specimen container is weighted in a lifted or elevated position. A processor communicatively coupled to the load cell may determine a weight of the specimen container based on the output.

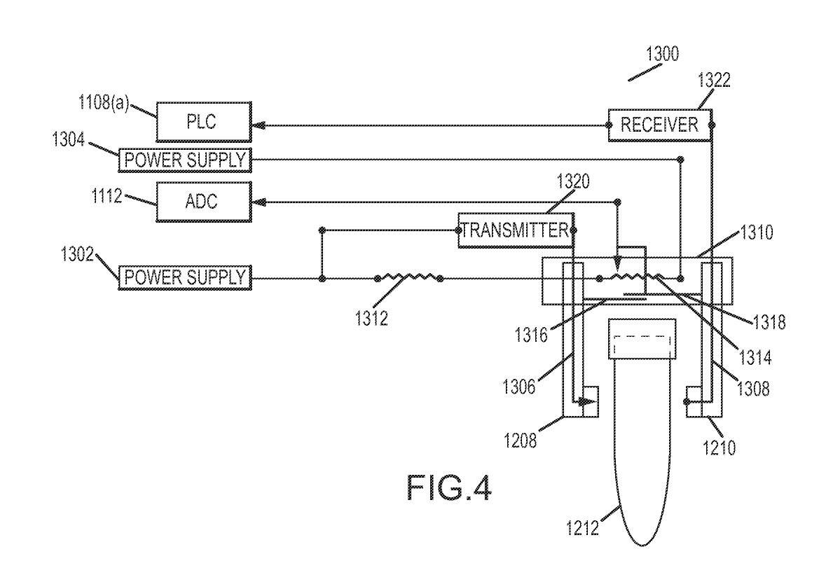

Certain components of the specimen gripper 1200 described with reference to FIG. 3 can be further understood as described with reference to the system diagram of FIG. 4. In FIG. 4, as in FIG. 3, the gripper fingers 1208 and 1210 of the gripper unit are configured to grip a specimen container such as the specimen container 1212. The specimen gripper 1200 may comprise a linear potentiometer 1310 (e.g., corresponding to the linear potentiometer 1202 of FIG. 3) that may be used to determine a weight of the specimen container 1212. The gripper unit 1200 may also include one or more optical sensor systems for determining information related to the specimen container 1212 and/or the contents of the specimen container 1212.

The linear potentiometer 1310 may include mechanical components 1316 and 1318 coupled to the gripper fingers 1208 and 1210, respectively. The linear potentiometer 1310 may include a resistor 1312 (e.g., 5 KΩ) and a resistor 1314 (e.g., 5 KΩ). In one embodiment, a power supply 1302 may represent a positive supply voltage (e.g., VCC) and a power supply 1304 may represent a negative supply voltage (e.g., GND). As gripper fingers 1208 and 1210 slide inward to grip the specimen container 1212, the mechanical components 1316 and 1318 move relative to one another, changing the resistance value of the linear potentiometer 1310. A signal having a voltage value proportional to the resistance value of the linear potentiometer 1310 can be received by the PLC 1108(a) via the ADC 1112. The diameter of the specimen container 1212 can be determined based on the voltage value. It will be recognized that other sensing devices can be used in lieu of a linear potentiometer to determine the diameter of a specimen container.

Voltages corresponding to resistance values of the linear potentiometer 1310 can be calibrated in association with positions of the gripper fingers 1208 and 1210 (e.g., at full open, full close, and 1-100 intermediate positions, such as two to thirty intermediate positions, e.g. ten positions). In this manner, nominal voltage ranges can be associated with various tube diameters as well as full open, full close, and/or “illegal” conditions. Illegal conditions may indicate an error state. For example, if the specimen gripper was commanded to grip a specimen container and a detected voltage (associated with the linear potentiometer 1310 and/or pneumatic actuator 1224) indicates a full closed condition, an error has occurred because the closed condition indicates that no specimen container was gripped. In another example, if the specimen gripper was commanded to grip the specimen container and a detected voltage indicates a full open condition, an error has occurred because the gripper fingers 1208 and 1210 have not closed on a specimen container, which could indicate an obstruction or a binding in the specimen gripper.

The configuration of one or more sensors in association with the gripper unit 1200 allows development of truth tables. The truth tables may associate various conditions, such as full open, full closed, and diameter of tube gripped, with values corresponding to distances between the gripper fingers 1208 and 1210. An illegal condition may occur when a determined distance between the gripper fingers 1208 and 1210 does not match an acceptable value for the current state of the specimen gripper. For example, if the specimen gripper has been commanded to grip a tube but a diameter determined by the linear potentiometer 1310 for the tube is not an accepted value for tube diameter, an illegal condition may occur. In another example, if a gripper is at a full open position as detected by the linear potentiometer 1310 and a presence sensor indicates the presence of a tube, a truth table may associate this combination of conditions with a potential “dangling tube” condition. An alert could be generated based on the dangling tube condition by the PLC 1108(a) that may be provided to the operator 1102.

Some embodiments of the invention utilizing the potentiometer may also include methods. Such methods may comprise gripping the specimen container using a plurality of gripper fingers, and then generating, by a sensing potentiometer, an output based on a distance between two gripper fingers in the plurality of gripper fingers. A processor coupled to the sensing potentiometer may determine a dimension such as a diameter of the specimen container based on the output.

In some embodiments, an optical sensor system may be used to detect whether a specimen container is present between the gripper fingers. In another example, an optical sensor system can be used to determine one or more liquid levels of sample material (e.g., serum, plasma, gel, packed red blood cells etc.) within the specimen container. Where multiple liquid types are present in a specimen container, the locations of interfaces between different liquid types can be determined. An optical sensor system can be used to determine a serum index. The liquid characteristics of one or more liquids within the specimen container can also be determined based on an attenuation of a signal from the light source as detected by the light receiver. In some embodiments, an optical sensor system can be used to determine one or more dimensions of a specimen container, such a length of a specimen container. An optical sensor system may further determine the presence and/or color of a cap of a specimen container.

The optical sensor system can include a radiation source (such as a light source) and a radiation receiver (such as a light receiver). A typical light source emits electromagnetic radiation in the visible spectrum. The term “light” as used herein may refer to any radiation. The radiation source may be, for example, a fiber optic source, a light emitting diode (LED), a laser diode, or a laser. The radiation receiver (also referred to as a “detector”) may be, for example, a fiber optic receiver or a photodiode. An amplifier may be coupled to the output of the detector for amplifying the received attenuated signals.

In one embodiment, an optical sensor system can include a fiber optic system including a fiber optic source 1306 and a fiber optic receiver 1308, as illustrated in FIG. 4. The fiber optic source 1306 may be coupled to a transmitter 1320 (e.g., U2-Keyance Transmitter) and the fiber optic receiver 1308 may be coupled to a receiver 1322 (e.g., U2-Keyance Receiver). In one embodiment, the fiber optic system is part of the sensor units 1120. The fiber optic source 1306 and the fiber optic receiver 1308 may be embedded with and coupled to the surfaces of the gripper fingers 1208 and 1210, respectively, and/or the jaws 1214 and 1216. In other embodiments, the fiber optic source 1306 and the fiber optic receiver 1308 may be attached to elongated structures forming at least part of the gripper fingers 1208, 1210. Alternatively, the fiber may be threaded through the gripper fingers. It will be recognized that other configurations may be used to connect the fiber to the surfaces of the gripper fingers. In some embodiments, an inline right angle connector or adapter is used in locations where the fiber traverses a corner that exceeds the bending tolerance of the fiber.

The presence or absence of the specimen container 1212 between the gripper fingers 1208 and 1210 can be determined based on a signal received by the PLC 1108(a) from the fiber optic receiver 1308. For example, if no specimen container is located between the gripper fingers 1208 and 1210, light emitted from the fiber optic source 1306 is received by the fiber optic receiver 1308. In this example, a signal is received by the PLC 1108(a) from the fiber optic receiver 1308 indicating the absence of a specimen container. When a specimen container is located between the gripper fingers 1208 and 1210, the light emitted from the fiber optic source 1306 is not received by the fiber optic receiver 1308 because the specimen container blocks some or all of the emitted light from the fiber optic source 1306. In this case, a signal is received by the PLC 1108(a) from the fiber optic receiver 1308 indicating the presence of a specimen container.

In some embodiments, measurements can be performed using the fiber optic system. For example, gripper fingers with the fiber optic source 1306 and the fiber optic receiver 1308 can be moved along a vertical axis relative to the specimen container 1212. Such a measurement is performed while the gripper fingers are not gripping the specimen container 1212. For a specimen container length measurement, gripper fingers with the fiber optic source 1306 and the fiber optic receiver 1308 can be lowered from a point above the specimen container 1212 (where the fiber optic receiver 1308 receives a beam of light emitted from the fiber optic source 1306 because the specimen container 1212 does not break the beam), along the length of the specimen container 1212 (where the fiber optic receiver 1308 does not receive a beam of light emitted from the fiber optic source 1306 because the specimen container 1212 breaks the beam), to a point below the specimen container 1212 (where the fiber optic receiver 1308 receives a beam of light emitted from the fiber optic source 1306 because the specimen container 1212 does not break the beam). The length of the specimen container 1212 can be determined based on the distance traversed by the gripper fingers over which the beam from the fiber optic source 1306 was attenuated or broken. One or more liquid levels in the specimen container 1212 can be similarly determined.

FIG. 5 shows an illustrative specimen carrier with cutouts to allow optical access to the specimen container. A specimen carrier 1400 used to transport a specimen container may have one or more slots 1402 to allow a specimen container 1406 to be visible to the optical sensing system. Slots 1402 may have a vertical orientation to allow the specimen gripper to perform measurements by traversing the length of the specimen container 1406 while the specimen container is held upright within the specimen carrier 1400. In some embodiments, the specimen carrier 1406 may allow for gripper fingers 1208, 1210 to move below the underside of the specimen container 1406 as shown by the space 1404 below the specimen container 1406. For example, the specimen carrier may have a lip or other feature to support the specimen container to create space between the underside of the specimen container and the lower interior surface of the specimen carrier. The gripper fingers 1208, 1210 can determine the length of the tube by moving along the length of the specimen container 1406 from above the top of the specimen container to below the underside of the specimen container, such that a radiation source and/or radiation receiver are aligned with one or more slots 1402.

In an alternative embodiment of a fiber optic system, the fiber optic receiver 1308 determines an amount by which light emitted from the fiber optic source 1306 is attenuated. For example, the amount by which the light is attenuated relative to a baseline light level may be determined. The baseline light level may be a predetermined value or may be established during a state when it is known that no obstruction exists between fiber optic source 1306 and the fiber optic receiver 1308.

The optical sensor system may include two or more light sources. Each light source may have an associated light receiver, such as a fiber optic receiver or photodiode. Alternatively, light from two or more fiber optic sources may be detected by a single light receiver using an optical device for mixing light. Alternatively, a beam combiner may be used to direct light from different light sources in parallel toward a specimen container.

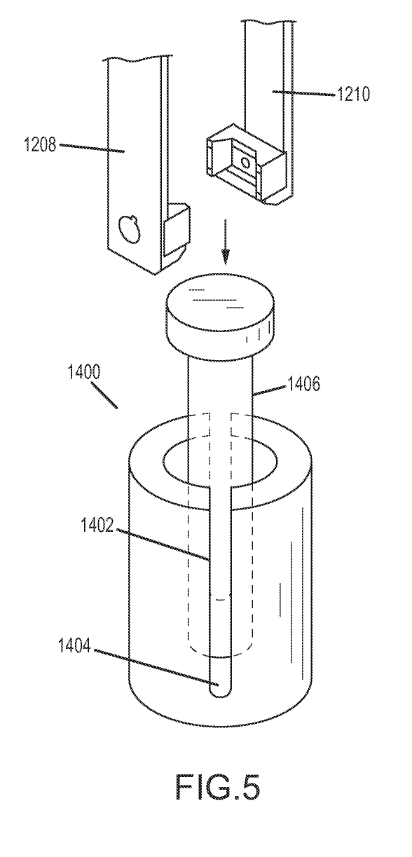

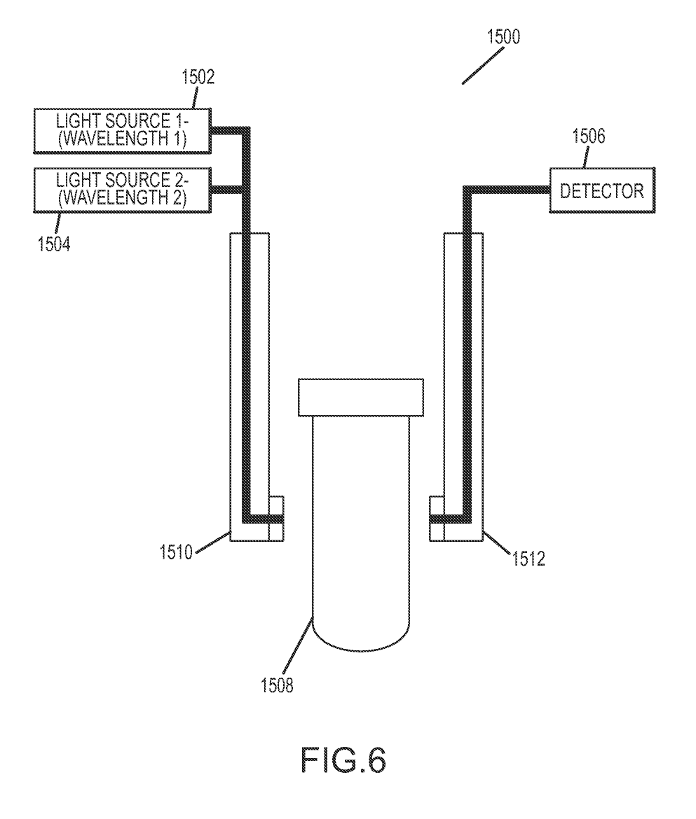

FIG. 6 shows an illustrative fiber optic system 1500 having multiple light sources. In one embodiment, the fiber optic system 1500 is part of the sensor units 1120. The fiber optic system 1500 includes a first light source 1502 and a second light source 1504 coupled to a first gripper finger 1510 and a detector 1506 coupled to a second gripper finger 1512.

The first gripper finger 1510 and the second gripper finger 1512 may be part of a specimen gripper, such as, the specimen gripper 1200. The first light source 1502 is arranged to apply a first signal beam having a first characteristic wavelength (in the range of 200 nm-1700 nm, such as between 800 nm-1200 nm, e.g., 980 nm) to a beam combiner (not shown) which directs the first transmitted signal toward a location on a specimen container 1508. The first light source can be detected by the detector 1506, such as a fiber optic receiver or photodiode. The second light source 1504 can be arranged to apply a second signal beam having a second characteristic wavelength (e.g., in the range of 200 nm-1700 nm, such as between 1000 nm-1400 nm, e.g., 1050 nm) to the beam combiner at a slightly shifted position from the first signal beam. The beam combiner can direct the second emitted signal beam parallel to the beam path of first emitted signal beam toward a slightly different location on the specimen container 1508. The second signal beam can be detected by the detector 1506. The output signal of the detector 1506 can be received by the processor 1108 for storage (e.g., in the memory 1110) and/or processing. The wavelength of light for the first light source 1502 may be selected such that the attenuation of the light through a particular fluid is minimal, allowing the first light source 1502 to be used as a reference. The wavelength of light for the second light source 1504 may be selected such that the attenuation is predictable for a fluid of interest.

Characteristics of various liquids within a specimen container (e.g., specimen container 1212), such as the opacity of the liquids, may vary. The varying liquid characteristics allow determination of liquid type of material in a specimen container based on a determination of the attenuation of light passing through the liquids. Measurement of the quantity of each of multiple liquids in a container may also be determined in this way. For example, serum and gel are mostly transparent to visible light while red blood cells are substantially opaque. Further, gel is transparent to infrared light while red blood cells and serum are substantially opaque. Accordingly, when a specimen container has gel (e.g., a synthetic gel for separating serum from red blood cells), it is possible just using infrared light to “see through” different sections. The infrared light reading is strong when the infrared light beam passes through air, drops when the infrared light beam is directed toward the serum, is relatively strong when directed toward the gel, and drops again when directed toward the red blood cells. A sample level detection system is described in detail in U.S. Provisional Patent Application No. 61/556,667, filed Nov. 7, 2011 and entitled “Analytical System and Method for Processing Samples” and PCT/US2012/063931 entitled “System and Method for Processing Samples,” filed on Nov. 7, 2012, which are incorporated by reference in their entirety for all purposes.

Laky or chylous samples, of lipemic, hemolytic or icteric patients commonly interfere with other laboratory tests that use optical methods. Thus, for reliable sample handling automation, it is desirable to measure serum index before a sample is committed to an analyzer for testing to avoid erroneous measurements. Liquid characteristics of laky or chylous liquids can be determined based on an attenuation of a signal from the light source as detected by the light receiver. Liquid characteristics used in specimen processing are described in detail in U.S. Provisional Patent Application No. 61/701,360, filed Sep. 14, 2012 and entitled “Analytical System with Capillary Transport,” which is incorporated by reference.

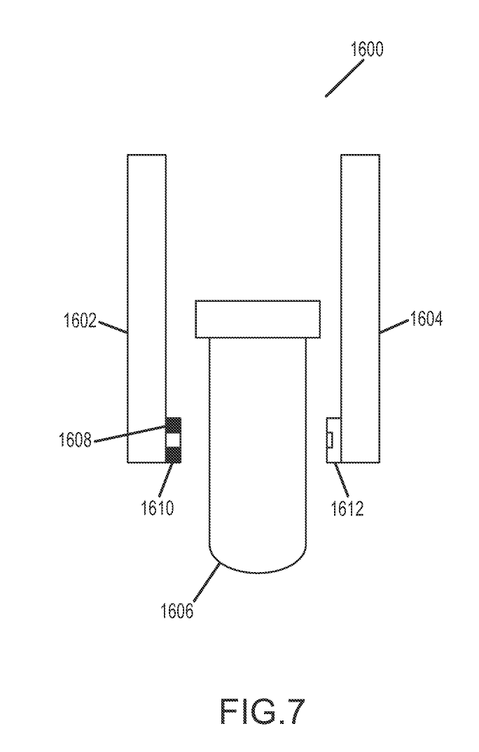

FIG. 7 shows fingers of a specimen gripper (e.g., gripper unit 1200) with an illustrative laser emitting diode (LED) and photodiode optical sensing system 1600. In one embodiment, the optical sensing system 1600 is part of the sensor units 1120. It will be recognized that an optical sensor system including one or more LEDs and one or more photodiode detectors could be used in lieu of the fiber optic system described above. In one embodiment, a first LED 1608 having a first wavelength and a second LED 1610 having a second wavelength may be coupled to the surface of a first gripper finger (or gripper fingertip or jaw) 1602 that faces a specimen container 1606. A photodiode 1612 may be coupled to a second gripper finger 1604 opposite the first gripper finger 1602 such that it's in a line of sight of the LEDs 1608 and 1610. It will be understood that for wired LEDs 1608,1610 and the photodiode 1612, wirings may pass through the first and second gripper fingers 1602, 1604. Alternatively, wireless components may be used.

The photodiode 1612 may be configured to receive the light transmitted by the LEDs and convert it to a current or voltage that may be provided to the PLC 1108(a) for further processing, e.g., for determining liquid level or characteristics and/or length of the tube, etc. The photodiode 1612 may be silicon based, germanium based or any other suitable type of photodiode.

Some embodiments of the invention may be directed to methods. Such methods may include transmitting, by a light source, an optical signal, the light source coupled to a first gripper finger in a plurality of gripper fingers gripping the specimen container. The method also includes receiving, by a light receiver, the optical signal, the light receiver being coupled to a second gripper finger in the plurality of gripper fingers gripping the specimen container, and then determining, by a processor coupled to the light source and the light receiver, information associated with the specimen container gripped by the plurality of gripper fingers. Such information may relate to the presence or absence of a specimen container between the gripper fingers, the type of liquid or liquids inside of the specimen container, the type or specimen container, the height of the liquid in the specimen container, the height of the specimen container, etc.

### Specimen Gripper Closure Assemblies

In various embodiments, the specimen gripper may have various assemblies for closing the gripper fingers to clasp a specimen container. Some embodiments allow the specimen gripper to grip tubes of different diameters and heights.

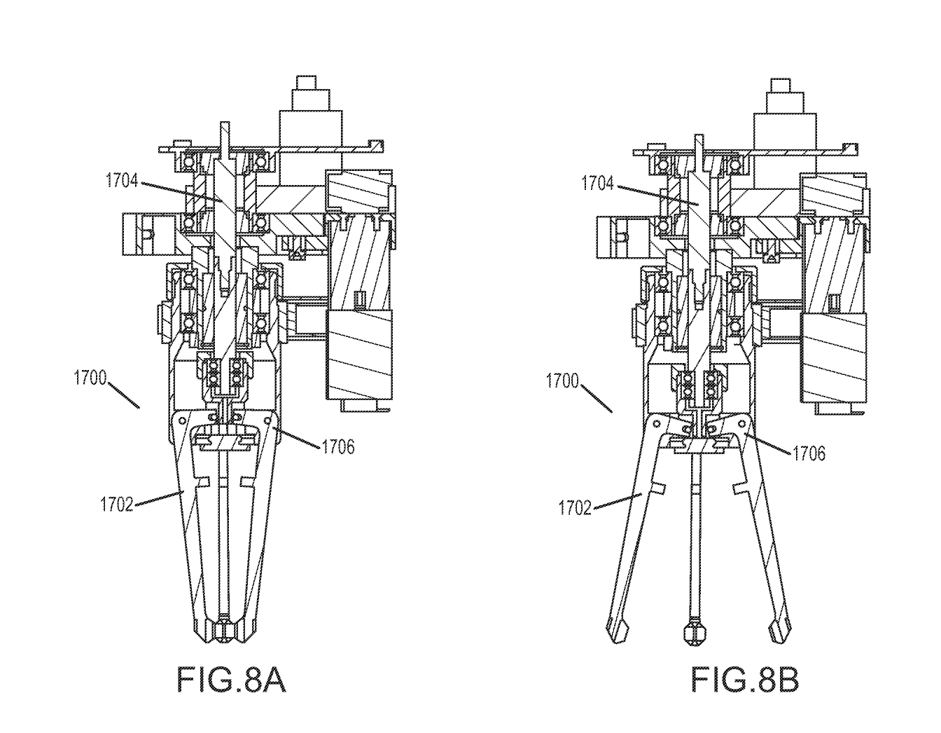

In some embodiments, closure of the gripper fingers about a specimen container is caused by rotation of gripper fingers around a pivot point. FIGS. 8A-8B illustrate a ball screw assembly for closing gripper fingers 1702 of a specimen gripper 1700 using a ball screw 1704 to cause rotation around a pivot point 1706. A ball screw linear actuator translates rotational motion to linear motion. The ball screw 1704 uses ball bearings in a helical raceway to form a precision screw. FIG. 8A shows the specimen gripper 1700 with ball screw driven gripper fingers 1702 in a closed position. FIG. 8B shows the specimen gripper 1700 with ball screw driven gripper fingers 1702 in an open position. The downward translation of the ball screw 1704 causes the gripper fingers 1702 to pivot outwards. Upward translation of the ball screw 1704 causes the gripper fingers 1702 to pivot inward. The inward pivoting of the griper fingers 1702 can cause the gripper fingers 1702 to close about the specimen container 1700. In one embodiment, the specimen gripper 1700 is similar to the gripper unit 1114 with the ball screw assembly coupled to the body 1116.

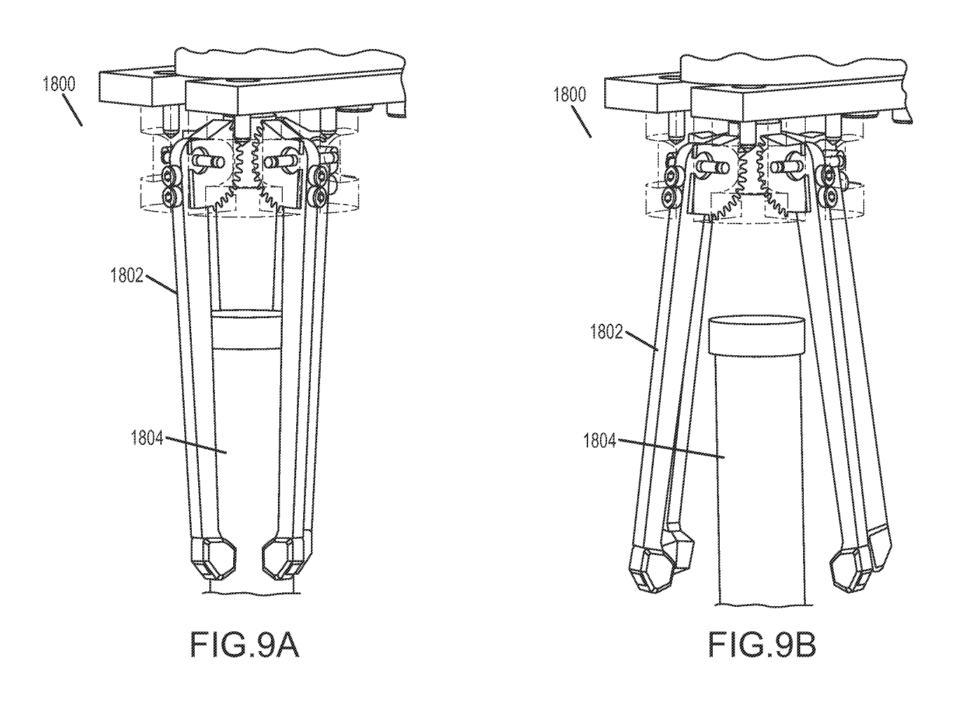

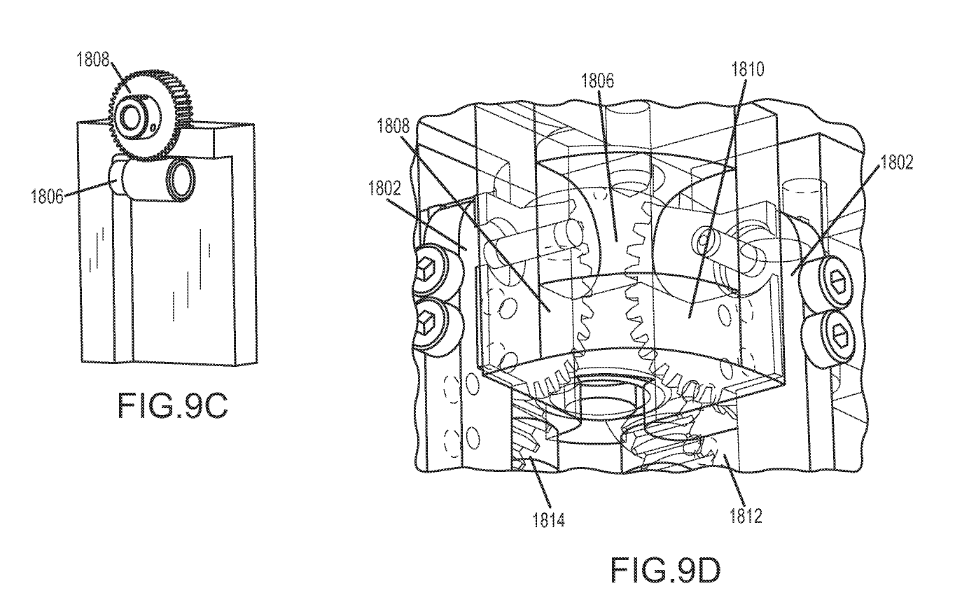

FIGS. 9A-9D show a worm drive assembly for closing gripper fingers 1802 of a specimen gripper 1800 about a specimen container 1804. FIG. 9A shows the specimen gripper 1800 with worm gear driven gripper fingers 1802 in a closed position. When closed about the specimen container 1804, worm gear driven gripper fingers 1802 clamp the specimen container 1804. FIG. 9B shows the specimen gripper 1800 with worm gear driven gripper fingers 1802 in an open position (e.g., to release specimen container 1804).

FIG. 9C shows an illustrative worm drive assembly. A worm drive can include a worm gear 1808 and a worm 1806. The rotation of the worm 1806 drives rotation of the worm gear 1808. FIG. 9D shows a worm drive in the context of the specimen gripper 1800. The worm 1806 can cause the rotation of multiple worm gears 1808-1814. Each worm gear may be associated with a gripper finger 1802. As the worm 1806 turns, worm gears 1808-1814 can rotate, causing the gripper fingers 1802 to pivot. Rotation of the worm 1806 in a first direction can cause the gripper fingers 1802 to pivot inward toward the specimen container 1804. Rotation of the worm 1806 in a second direction can cause the gripper fingers 1802 to pivot (e.g., to release the specimen container 1804).

In one embodiment, the specimen gripper 1800 is similar to the gripper unit 1114 such that the worm drive assembly can be coupled to the body 1116. In some embodiments, one or more holes may be added to allow the gears to be mounted on the gripper fingers.

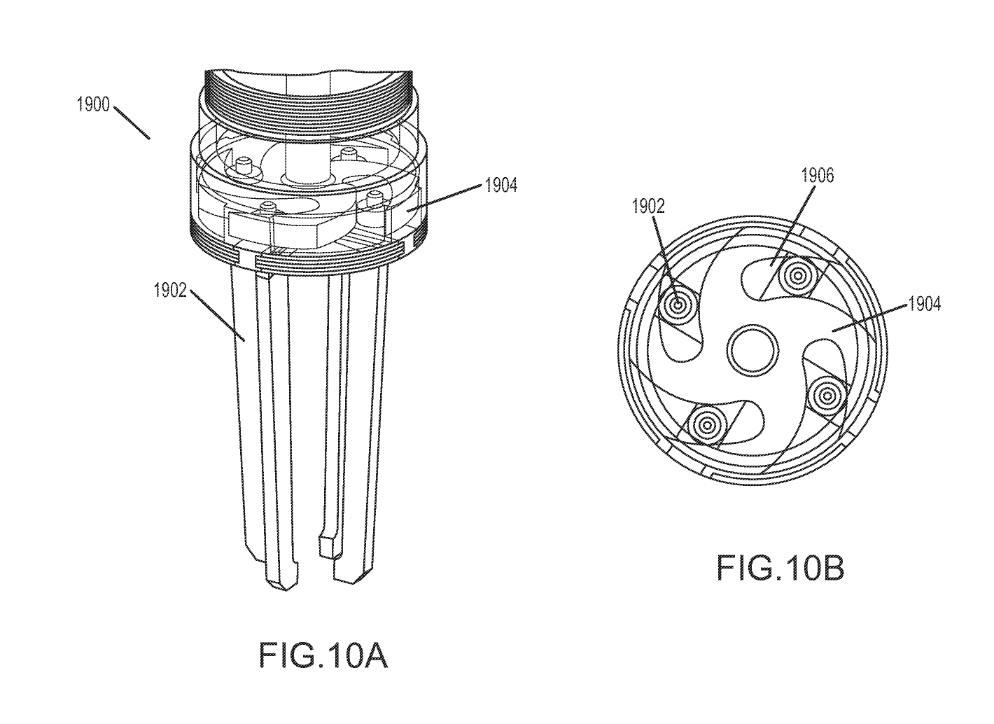

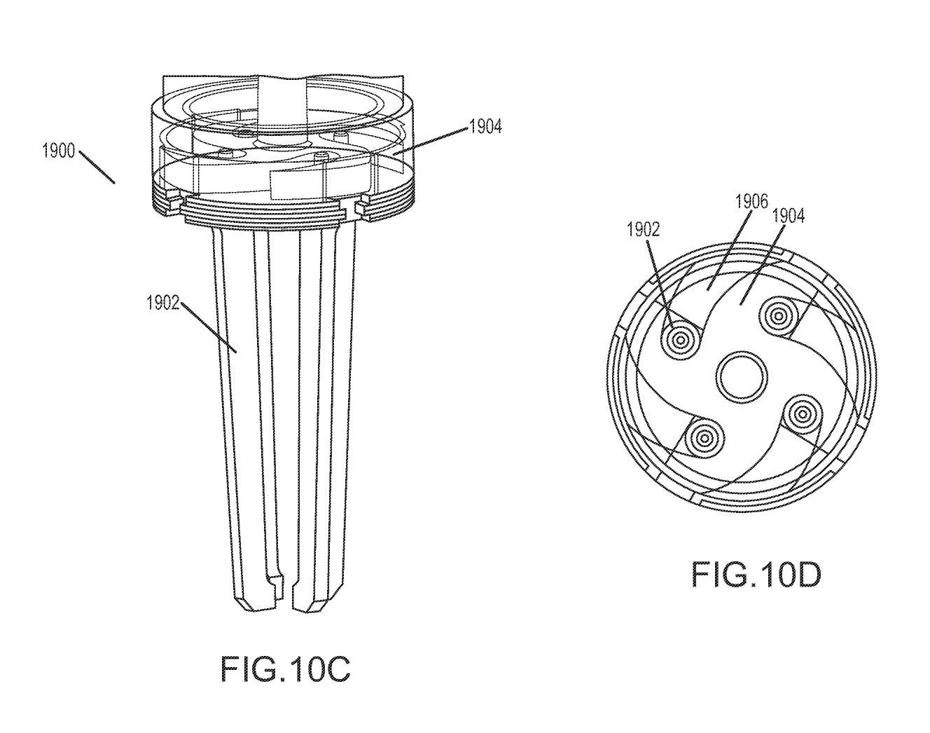

In some embodiments, closure of the gripper fingers about a specimen container is caused by movement of gripper fingers through a rotating disc with angular slots. FIGS. 10A-10D show a slotted disc assembly for closing gripper fingers 1902 of a specimen gripper 1900. FIG. 10A shows the specimen gripper 1900 with slotted disc driven gripper fingers 1902 in an open position. FIG. 10B shows a section of the specimen gripper viewed from above slotted disc 1904 with slotted disc driven gripper fingers 1902 in an open position. FIG. 10C shows a specimen gripper with slotted disc driven gripper fingers 1902 in a closed position. FIG. 10D shows a section of the specimen gripper viewed from above slotted disc 1904 with slotted disc driven gripper fingers 1902 in a closed position. As slotted disc 1904 rotates, gripper fingers 1902 are urged along the paths defined by slots 1906 in slotted disc 1904. Rotation of disc 1906 in a first direction can cause gripper fingers 1902 to move along slots 1906 inward toward a closed position. Rotation of disc 1906 in a second direction can cause gripper fingers 1902 to move along slots 1906 outward toward an open position. The spline shape of slots 1906 shown in FIGS. 10A-10D can be advantageous in that the angle under which force is applied by rotating disc 1904 to gripper finger 1902 is always the same. It will be recognized that other shapes, such as a linear slot shape, may be used.

In one embodiment, the specimen gripper 1900 is similar to the gripper unit 1114 such that the slotted disc assembly can be coupled to the body 1116.

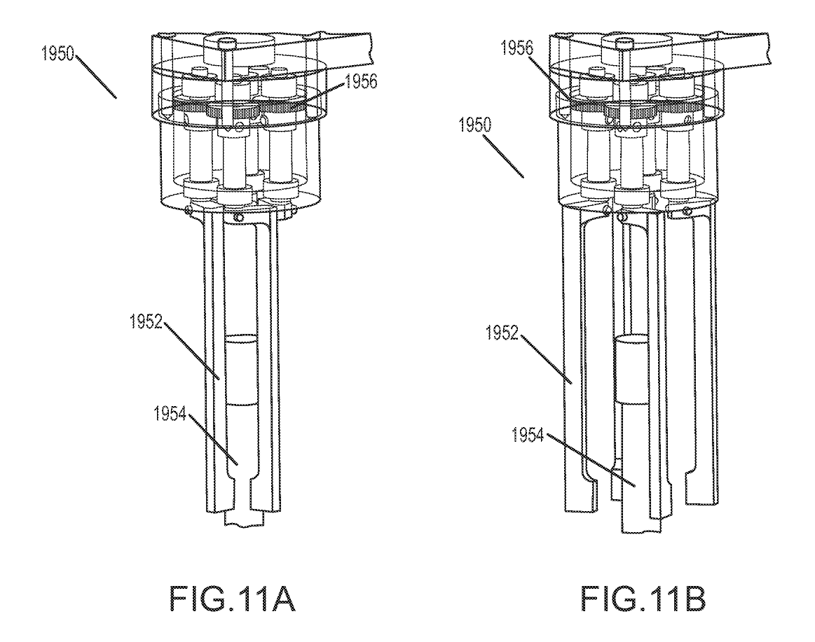

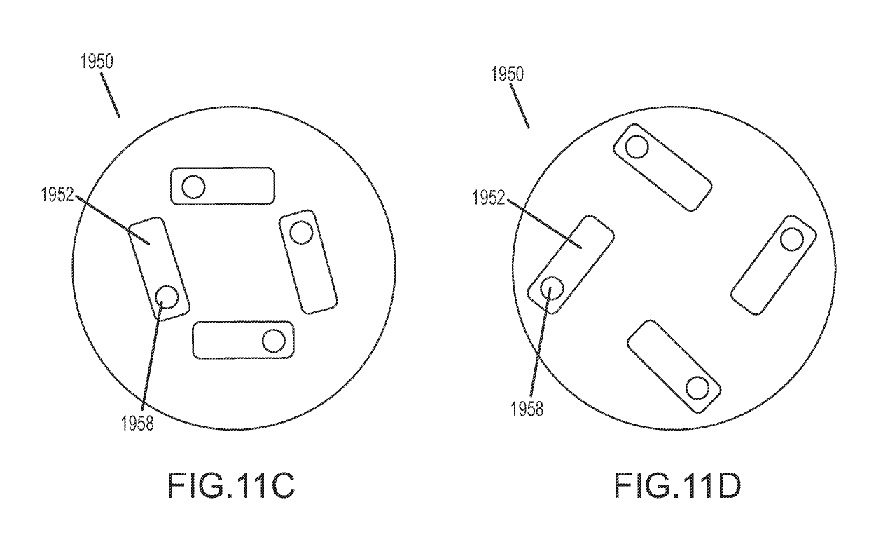

In some embodiments, closure of the gripper fingers about a specimen container is caused by rotation of a planetary gear having a planet gear coupled to each gripper finger 1952 of a specimen gripper 1950. FIGS. 11A-11B show a planetary gear assembly for closing gripper fingers 1952 of the specimen gripper 1950. FIG. 11A shows a specimen gripper with planetary gear driven gripper fingers 1952 closed about a specimen container 1954. FIG. 11B shows a specimen gripper with planetary gear driven gripper fingers 1952 in an open position.

FIGS. 11C-11D show sections of the specimen gripper viewed from below planetary gear system 1956. A planetary gear system can have one or more outer gears (i.e., “planet gears”). The planet gears may revolve around a central gear (i.e., “sun gear”). FIG. 11C shows a section of the specimen gripper with planetary gear driven gripper fingers 1952 in a closed position corresponding to FIG. 11A. The point of attachment between gripper finger 1952 and a planetary gear of the planetary gear system 1956 is shown at 1958. As planet gears 1956 rotate, gripper fingers 1952 rotate to an open position as shown in FIG. 11D, corresponding to FIG. 11B.

In one embodiment, the specimen gripper 1950 is similar to the gripper unit 1114 such that the planetary gear assembly can be coupled to the body 1116.

Embodiments allow gripping different tube diameters and lengths with reliable and fast to repair features. The specimen gripper in accordance with various embodiments makes multiple measurements simultaneously affording a better method of managing the specimen containers. For example, by determining the diameter, height, length and the cap color of the specimen container before picking it up, the embodiments provide faster speed and further qualify that it's safe to optimally route the specimen containers to other modules for further processing.

### IV. Computer Architecture

The various participants and elements described herein with reference to the figures may operate one or more computer apparatuses to facilitate the functions described herein. Any of the elements in the above description, including any servers, processors, or databases, may use any suitable number of subsystems to facilitate the functions described herein, such as, e.g., functions for operating and/or controlling the functional units and modules of the laboratory automation system, transportation systems, the scheduler, the central controller, local controllers, etc.

Examples of such subsystems or components are shown in FIG. 12. The subsystems shown in FIG. 12 are interconnected via a system bus 10. Additional subsystems such as a printer 18, keyboard 26, fixed disk 28 (or other memory comprising computer readable media), monitor 22, which is coupled to display adapter 20, and others are shown. Peripherals and input/output (I/O) devices, which couple to I/O controller 12 (which can be a processor or other suitable controller), can be connected to the computer system by any number of means known in the art, such as serial port 24. For example, serial port 24 or external interface 30 can be used to connect the computer apparatus to a wide area network such as the Internet, a mouse input device, or a scanner. The interconnection via system bus allows the central processor 16 to communicate with each subsystem and to control the execution of instructions from system memory 14 or the fixed disk 28, as well as the exchange of information between subsystems. The system memory 14 and/or the fixed disk 28 may embody a computer readable medium.

Embodiments of the technology are not limited to the above-described embodiments. Specific details regarding some of the above-described aspects are provided above. The specific details of the specific aspects may be combined in any suitable manner without departing from the spirit and scope of embodiments of the technology. For example, back end processing, data analysis, data collection, and other processes may all be combined in some embodiments of the technology. However, other embodiments of the technology may be directed to specific embodiments relating to each individual aspect, or specific combinations of these individual aspects.

It should be understood that the present technology as described above can be implemented in the form of control logic using computer software (stored in a tangible physical medium) in a modular or integrated manner. Furthermore, the present technology may be implemented in the form and/or combination of any image processing. Based on the disclosure and teachings provided herein, a person of ordinary skill in the art will know and appreciate other ways and/or methods to implement the present technology using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the technology will become apparent to those skilled in the art upon review of the disclosure. The scope of the technology should, therefore, be determined not with reference to the above description, but instead should be determined with reference to the pending claims along with their full scope or equivalents.

One or more features from any embodiment may be combined with one or more features of any other embodiment without departing from the scope of the technology.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A system for gripping a specimen container, the system comprising:
a plurality of gripper fingers;
a processor; and
a sensing potentiometer communicatively coupled to the processor, wherein the sensing potentiometer is configured to produce an output based on a distance between two gripper fingers in the plurality of gripper fingers when a specimen container is gripped by the plurality of gripper fingers, and
wherein the processor is configured to determine a dimension of the specimen container based on the output.

2. The system of claim 1, wherein the output is a voltage value corresponding to a resistance value of the potentiometer.

3. The system of claim 1, wherein the sensing potentiometer is a linear potentiometer.

4. The system of claim 1, wherein the dimension is a diameter of the specimen container.

5. The system of claim 1 further comprising a load cell communicatively coupled to the processor, wherein the processor is further configured to determine a weight of the specimen container based on an output of the load cell.

6. The system of claim 5 further comprising:
an optical sensor system including a light source communicatively coupled to the processor and a light receiver communicatively coupled to the processor,
wherein the light source is coupled to a first gripper finger and the light receiver is coupled to a second gripper finger.

7. The system of claim 6 further comprising:
a photo transistor communicatively coupled to the processor; and
a light emitting diode;
wherein the light emitting diode is configured to generate light that is reflected from a surface of a cap of the specimen container when the specimen container is gripped by the plurality of gripper fingers; and
wherein the photo transistor is configured to generate a signal corresponding to a quantity of reflected light from the surface of the cap of the specimen container.

8. The system of claim 1 further comprising an assembly for opening and closing the plurality of gripper fingers, the assembly being a worm drive assembly, a slotted disc assembly, or a planetary gear assembly.

9. A method for determining a diameter of a specimen container, the method comprising:
gripping the specimen container using a plurality of gripper fingers;
generating, by a sensing potentiometer, an output based on a distance between two gripper fingers in the plurality of gripper fingers; and
determining, by a processor coupled to the sensing potentiometer, a dimension of the specimen container based on the output.

10. The method of claim 9 further comprising, one or more of:
a) generating, by a load cell, an output, and determining, by a processor communicatively coupled to the load cell, a weight of the specimen container based on the output;
b) transmitting, by a light source, an optical signal, the light source coupled to a first gripper finger in a plurality of gripper fingers gripping the specimen container, receiving, by a light receiver, the optical signal, the light receiver being coupled to a second gripper finger in the plurality of gripper fingers gripping the specimen container, and determining, by a processor coupled to the light source and the light receiver, information associated with the specimen container gripped by the plurality of gripper fingers; and
c) transmitting light generated by a light emitting diode directed towards a cap of the specimen container, and receiving light reflected from a surface of the cap of the specimen container by a photo transistor communicatively coupled to a processor; wherein the photo transistor is configured to generate a signal corresponding to a quantity of reflected light from the surface of the cap of the specimen container.

11. A system for gripping a specimen container, the system comprising:
a plurality of gripper fingers;
a processor; and
a load cell communicatively coupled to the processor, the processor configured to determine a weight of the specimen container based on an output of the load cell, when the plurality of gripper fingers grip the specimen container.

12. The system of claim 11, wherein the output of the load cell corresponds to a combined weight of the specimen container and a gripper unit configured to grip the specimen container using the plurality of gripper fingers.

13. The system of claim 12, wherein the weight of the specimen container is determined by subtracting a known weight of the gripper unit from the combined weight.

14. The system of claim 11, wherein the load cell is arranged on top of a gripper unit configured to grip the specimen container using the plurality of gripper fingers.

15. A method for determining a weight of a specimen container, the method comprising:
gripping the specimen container using a plurality of gripper fingers;
generating, by a load cell, an output; and
determining, by a processor communicatively coupled to the load cell, a weight of the specimen container based on the output.

16. A system for gripping a specimen container, the system comprising:
a plurality of gripper fingers comprising a first gripper finger and a second gripper finger;
a processor; and
an optical sensor system including a light source communicatively coupled to the processor and a light receiver communicatively coupled to the processor;
wherein the light source is coupled to the first gripper finger and the light receiver is coupled to the second gripper finger.

17. The system of claim 16, wherein the light source is a fiber optic source and the light receiver is a fiber optic receiver.

18. The system of claim 16, wherein the light source is a light emitting diode and the light receiver is a photodiode.

19. The system of claim 16, wherein the processor is configured to determine that a specimen container is determined to be present between the gripper fingers when the light receiver does not receive an optical signal from the light source.

20. The system of claim 16, wherein the processor is configured to determine liquid level of one or more liquids within the specimen container based on an attenuation of a signal from the light source as detected by the light receiver.

21. The system of claim 16, wherein the processor is configured to determine a liquid characteristic of a liquid within the specimen container based on an attenuation of a signal from the light source as detected by the light receiver.

22. The system of claim 16, wherein the processor is configured to determine a length of a specimen container based on an amount of time when light from the light source is attenuated at the light receiver when the gripper fingers descend vertically relative to the specimen container.

23. A method for obtaining information associated with a specimen container, the method comprising:
transmitting, by a light source, an optical signal, the light source coupled to a first gripper finger in a plurality of gripper fingers gripping the specimen container;
receiving, by a light receiver, the optical signal, the light receiver being coupled to a second gripper finger in the plurality of gripper fingers gripping the specimen container;
determining, by a processor coupled to the light source and the light receiver, information associated with the specimen container gripped by the plurality of gripper fingers.

24. A system comprising:
a plurality of gripper fingers;
a processor;
a photo transistor communicatively coupled to the processor; and
a light emitting diode;
wherein the light emitting diode is configured to generate light that is reflected from a surface of a cap of the specimen container when the specimen container is gripped by the plurality of gripper fingers; and
wherein the photo transistor is configured to generate a signal corresponding to a quantity of reflected light from the surface of the cap of the specimen container.

25. The system of claim 24,
wherein a distance between the photo transistor and the cap of the specimen container is determined based on the signal; and
wherein a length of the specimen container is determined based on the distance between the photo transistor and the cap of the specimen container.

26. The system of claim 24, wherein a cap color is determined based on the signal.

27. A method for obtaining information from a specimen container, the method comprising:
transmitting light generated by a light emitting diode directed towards a cap of the specimen container;
receiving light reflected from a surface of the cap of the specimen container by a photo transistor communicatively coupled to a processor;
wherein the photo transistor is configured to generate a signal corresponding to a quantity of reflected light from the surface of the cap of the specimen container.
